(19) United States
(12) Patent Application Publication
(10) Pub. No.: US 2007/0145879 A1
(43) Pub. Date: Jun. 28, 2007

(54) Light emitting halogen-silicate photophosphor compositions and systems

(76) Inventors: Vladimir Semenovich Abramov, Moscow (RU); Naum Petrovich Soschin, Moscow (RU); Alexander Valerievich Shishov, Bykovo (RU); Nikolay Valentinovich Scherbakov, Moscow (RU)

Correspondence Address: ACOL TECHNOLOGIES S.A., P.O. BOX 757, LA JOLLA, CA, 92038, US

(21) Appl. No.: 11/316,177

(22) Filed: Dec. 22, 2005

(51) Int. Cl. H01J 1/62

(52) U.S. Cl. 313/483; 313/503

(57) ABSTRACT

New high-performance, highly tunable photophosphors are presented. These photophosphor's pump spectra and emission spectra are both manipulated via variances in the formulation of compounds taught herein. In addition, new combinations of semiconductor devices in conjunction with these optically active materials are described. In particular, light emitting semiconductors fashioned as diodes from indium gallium nitride construction are combined with these photophosphors. High-energy short wavelength light mixes with the longer wavelengths light emitted by the halogen-silicate photophosphor to produce a broad spectrum perceived by human observers as “white light”.

### BACKGROUND OF THESE INVENTIONS

1. Field

The following inventions disclosure is generally concerned with compositions having light emitting functionality and more specifically concerned with compostions arranged to provide a wavelength shifting function in for example light emitting diodes.

2. Prior Art

For the first time the suggestion to incorporate Stoke's phosphor to the surface of indium-gallium light-emitting diode was recorded in the inventor certificate in favor of Abramov and others, numbered USSR No 697142. Considerable progress in physics of nitride light-emitting diodes, realized by S. Nakamura, “The blue laser diode”; chap 4. p 343-350; Springer-Verlag Berlin 1997; finally led to creating industrial “white” color light-emitting diodes.

Shimizu presents similar invention in his U.S. Pat. No. 5,998,925, which we consider as an analogue. According to this patent, for semiconductor structures of InGaN, it is suggested using photophosphor out of aluminium-yttrium garnet in accordance with the formula:
Y_{3-x-y}GdₓCe₃(Al,Ga)₅O₁₂.

Combining such photophosphor with light from a semiconductor, i.e. yellow light at approximately λ=560 nm, allows one to achieve a combined output radiation of a white nature or close to white color with various color tints (bluish, yellowish etc.) This construction became widely used in manufacturing, though it is not devoid of deficiencies including at least:
Relatively low color rendering, defined in the form of color index Rₐ≦70 units;
Insufficiently high optical emission output out of aluminium-yttrium garnet (photophosphor) due to a large difference in refraction indices of phosphor grains (n=1.95) and organic polymer (n=1.45) used as glue for fixing grains to emitting facets of a light-emitting diode;
High cost of phosphor conditioned by using expensive rare-earth metals such as yttrium, gadolinium, cerium at the phosphor synthesis.

All the mentioned deficiencies led to creating a new photophosphor for light-emitting diodes, the base of which are strontium orthosilicates with a general formula:
Sr₂₋ₓEuₓSiO₄.

Orthosilicate photophosphor emits in green or green-yellowish areas of visible spectrum (from λ=520 nm up to λ=550 nm) with half-width of radiation spectrum equal λ_{0.5}=80 nm±20 nm. It is expected that orthosilicate photophosphors will compete with standard aluminium-yttrium materials. Nevertheless, orthosilicate photophosphors also have considerable deficiencies, among which include:
Short-wave shift of absorption area towards UV spectrum side, that requires light-emitting diodes having emittion in the near UV or violet spectrum area;
Relatively low quantum emission output of orthosilicate (40-70%) in comparison with a high value for aluminium-yttrium photophosphor (85-95%); and
A narrow band spectral range of maximum emission (520-550 nm); said ‘tuning’ achievable only by changing the concentration of the activating ion (Eu⁺²).
   These deficiencies reduce the functionality possible with orthosilicate and therefore wide use is probably not to be expected. It is necessary to find a photophosphor with improved tuning and sufficiently high quantum efficiency.

Particular attention is drawn to US patent application publication numbered 2004/0251809, which discloses a phosphor and light emitting device using same phosphor. In particular, a phosphor comprising a host material composed of a compound having a garnet crystal structure represented by the general formula:
M¹ₐM²_{b}M³_{c}O_{d}

Wherein M¹ is a die feeling metal elements, M² is a trivalent metal element, M³ is a tetravalent metal element containing at least Si, ‘a’ is between 2.7 to 3.3, ‘b’ is 1.8 to 2.2, and ‘c’ is between 2.7 and 3.3, and ‘d’ is a number 11.0-13.0. It is particularly important to note that this a material is based upon the garnet crystal structure. In addition, the absence of halogens is notable.

Inventors Tasch, et al teaching U.S. Pat. No. 6,809,347 issued Oct. 26, 2004 luminophore which comes from the group of alkaline earth orthosilicates and which absorbs a portion of light emitted by a light source and emits light in another spectral region. These alkaline earth orthosilicate photophosphors are activated with bivalent europium. To improve the broadband nature of these systems, additional luminophore selected from the group of alkaline earth aluminates activated with bivalent europium and/or manganese, and additional luminophore of a red-emitting type selected from the group Y(V,P, Si)O₄:Eu or can contain up claim earth magnesium disilicate.

Yet another white light system is presented by Taiwanese company Vtera Technology Inc. in U.S. Pat. No. 6,825,498. In this system a ‘P’-type ZnTe layer or ZnSe layer is formed along with the LED. Blue light from the LED is absorbed by the ZnTe or ZnSe layer and converted in wavelength to a yellow green light. In this manner, a wavelength conversion layer is provided in conjunction with a typical blue emitting LED.

Inventors Ellen's et al, present in their disclosure, U.S. Pat. No. 6,759,804 issued Jul. 6, 2004 illumination devices with at least one LED as a light source. Wavelength conversion is achieved by way of a phosphor which originates from the class of (Eu, Mn)-coactivated halophosphates, where the cation and is one of the metals Sr, Ca, Ba.

The same inventors further teach in their U.S. Pat. No. 6,674,233 further inventions relating to illumination units having an LED as a light source. However these systems include phosphors from the class of cerium activated sialons, the sialon corresponding to the formula:
M_{p/2}Si_{12-p-q}Al_{p+q}O_{q}N_{16-q}:Ce³⁺

U.S. Pat. No. 6,501,100 is entitled: “White light emitting phosphor blend for LED devices”. There is provided a white light illumination system including a radiation source, a first luminescent material having a peak emission wavelength of about 570 to about 620 nm, and a second luminescent material having a peak emission wavelength of about 480 to about 500 nm, which is different from the first luminescent material. The LED may be a UV LED and the luminescent materials may be a blend of two phosphors. The first phosphor may be an orange emitting Eu²⁺, Mn²⁺ doped strontium pyrophosphate, (Sr_{0.8}Eu_{0.1}Mn_{0.1})₂P₂O₇. The second phosphor may be a blue-green emitting Eu²⁺ doped SAE, (Sr_{0.90-0.99}Eu_{0.01-0.1})₄Al₁₄O₂₅. A human observer perceives the combination of the orange and the blue-green phosphor emissions as white light.

In U.S. Pat. No. 6,577,073 an LED lamp includes blue and red LEDs and a phosphor. The blue LED produces an emission at a wavelength falling within a blue wavelength range. The red LED produces an emission at a wavelength falling within a red wavelength range. The phosphor is photoexcited by the emission of the blue LED to exhibit a luminescence having an emission spectrum in an intermediate wavelength range between the blue and red wavelength ranges.

U.S. Pat. No. 6,621,211 presents white light emitting phosphor blends for LED devices. There is provided white light illumination system including a radiation source, a first luminescent material having a peak emission wavelength of about 575 to about 620 nm, a second luminescent material having a peak emission wavelength of about 495 to about 550 nm, which is different from the first luminescent material and a third luminescent material having a peak emission wavelength of about 420 to about 480 nm, which is different from the first and second luminescent materials. The LED may be a UV LED and the luminescent materials may be a blend of three or four phosphors. The first phosphor may be an orange emitting Eu²⁺, M⁺ activated strontium pyrophosphate, Sr₂P₂O₇:Eu²⁺, Mn²⁺. The second phosphor may be a blue-green emitting Eu activated barium silicate, (Ba,Sr,Ca)₂SiO₄:Eu²⁺. The third phosphor may be a blue emitting SECA phosphor, (Sr,Ba,Ca)₅PO₄)₃Cl:Eu²⁺. Optionally, the fourth phosphor may be a red emitting Mn⁴⁺ activated magnesium fluorogermanate, 3.5MgO0.5MgF₂GeO₂:Mn⁴⁺. A human observer perceives the combination of the orange, blue-green, blue and/or red phosphor emissions as white light.

Clearly the art is filled with many interesting variations relating to the chemistry of photophosphors and their performance and characteristics.

While systems and inventions of the art are designed to achieve particular goals and objectives, some of those being no less than remarkable, these inventions have limitations which prevent their use in new ways now possible. Inventions of the art are not used and cannot be used to realize the advantages and objectives of these inventions taught herefollowing.

### SUMMARY OF THE INVENTIONS

Comes now, Abramov, V. S.; Soschin, N. P.; Shishov, A. V.; and Scherbakov, N. V., with inventions of a light emitting photophosphors including compositions of matter and methods of forming same compositions. It is a primary function of these inventions to provide materials use for color shifting in light emitting diode systems.

New high-performance halogen-silicate photophosphors are presented. In addition, combinations of these special high-performance photophosphors along with particular light emitting diodes namely, InGaN type diodes, which emit light in the ultraviolet and blue spectral regions are first suggested here.

A general formula is presented which defines the photophosphor class. For the sake of comparison with the prior art, attention is drawn to differences between closest similar phosphors in this new class as defined by the general formula.

Several example members of the photophosphor class are presented as illustrative examples. Discussion is directed to various properties observed in view of these particular examples.

Additionally, this disclosure also presents various ways of synthesizing phosphors in accordance with formulae presented. Finally, several examples of how one might synthesize such photophosphors is detailed.

### OBJECTIVES OF THESE INVENTIONS

It is a primary object of these inventions to provide new compositions and chemistry which result in photophosphors with new functionality.

It is an object of these inventions to provide photoluminescent materials for use with semiconductor emitters.

It is an objective of the present inventions to create a phosphor based on strontium silicate with a high quantum output value.

Another invention purpose is creating a phosphor with larger control of photophosphor excitation and emission spectral maxima.

It is a further object to provide new phosphor color shifting mechanisms to produce high performance white LED systems.

A better understanding can be had with reference to detailed description of preferred embodiments and with reference to appended drawings. Embodiments presented are particular ways to realize these inventions and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present invention will become better understood with regard to the following description, appended claims and drawings where:

FIG. 1 is an emission spectrum for an example phosphor of these inventions;

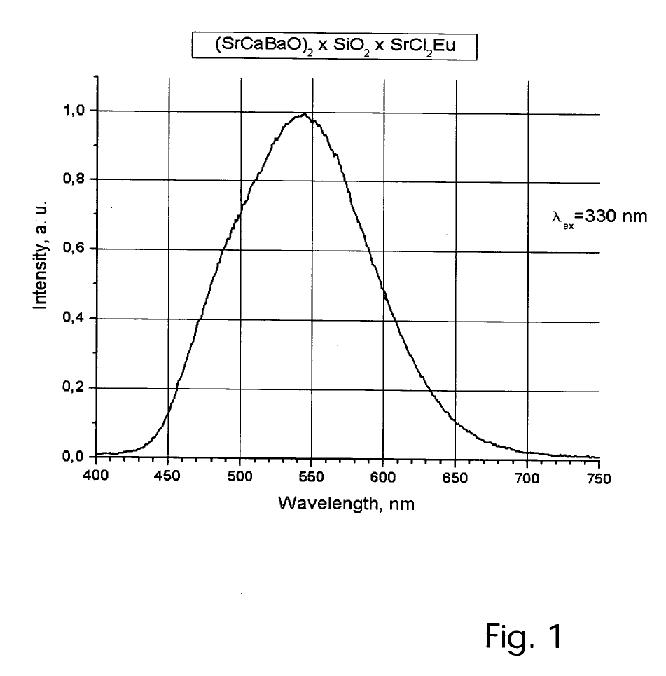

FIG. 2 is an excitation spectrum for the same material;

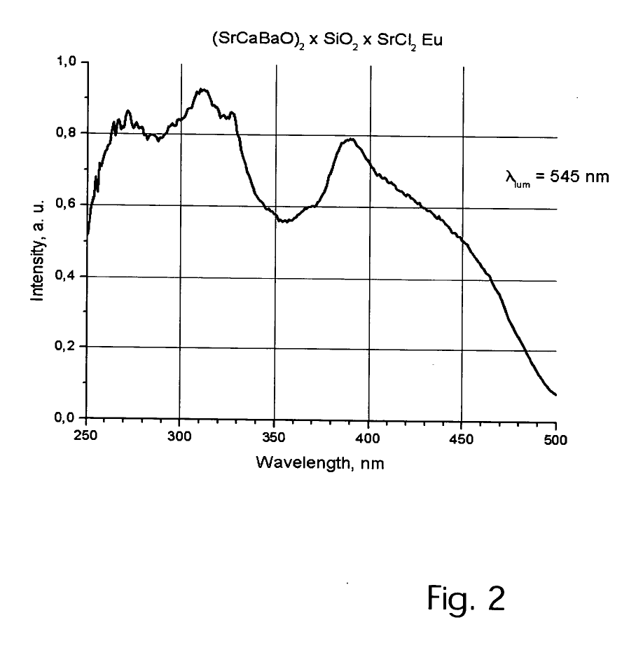

FIG. 3 is a prior art drawing showing the emission spectra of a YAG based phosphor; and

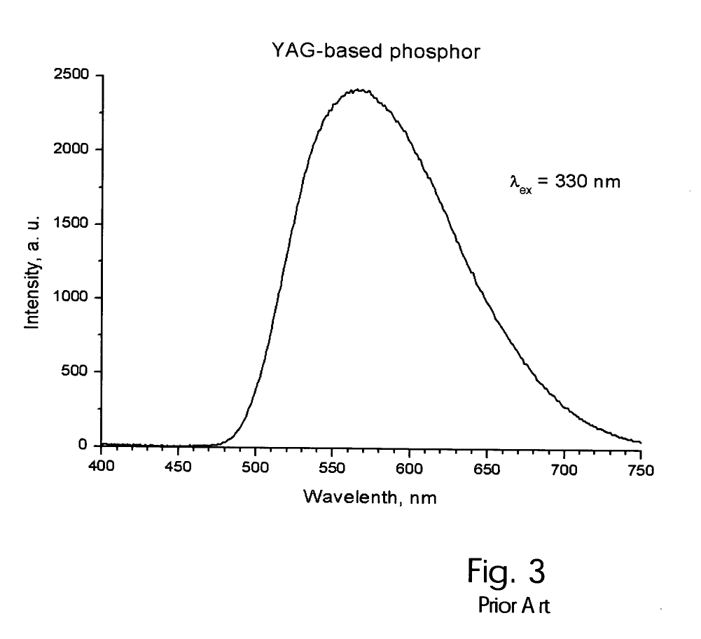

FIG. 4 shows the excitation of same YAG phosphor.

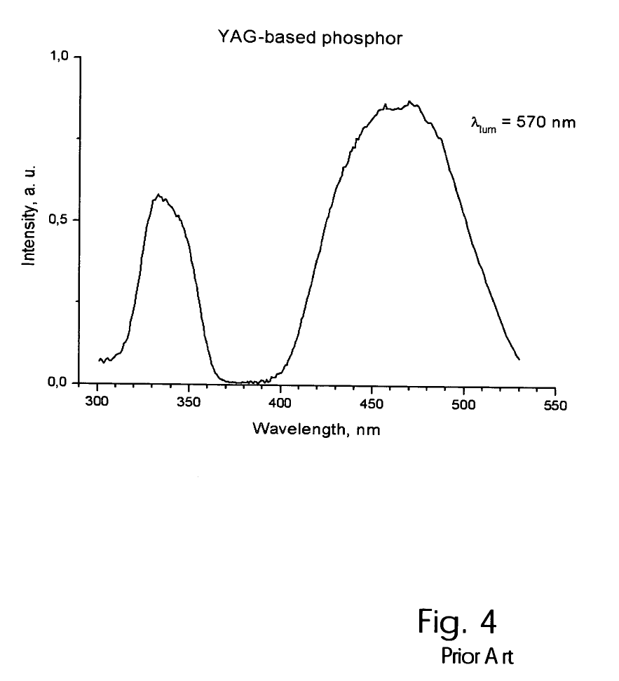

### PREFERRED EMBODIMENTS OF THESE INVENTIONS

In accordance with each of preferred embodiments of these inventions, wavelength shifting photophosphor compositions and methods of forming same are provided. It will be appreciated that each of embodiments described include both a composition and method and that the composition and method of one preferred embodiment may be different than the composition and method of another embodiment.

A family of new photophosphors is defined and presented herefollowing. Further, several preferred examples of family members are set forth in detail for illustration. This family of photophosphors is based upon siliceous combinations of strontium activated by bivalent europium ions. Further, the composition is modified in that strontium halogenides from the group SrF₂ or SrCl₂ are added to these phosphor compositions.

In general, a stoichiometric formula representing the family may be written as:
((SrO)₁₋ₓ[Me]Oₓ)ₐ*(SiO₂)_{b}*SrF_{2-y}Cl_{y}:(EuO)_{z}

where
a=either 1, 2, or 3;
b=either 1, or 2;
x=between 0.001 and 0.1;
y=between 0.01-1.2;
z=between 0.001-0.1; and
Me=either Ba⁺², Yb⁺², or Sm⁺².

One very important characteristic of this family includes the ability to shift the emission spectrum to ‘tune’ the output emission spectra to preferred and desirable values. In particular, the ratio of chlorine and flourine molecules operate to shift the emission spectra in useful ways. By changing the value of ‘y’ in the equation above, this ratio is manipulated and results in spectral shifts. When ‘y’ is decreased, less chlorine is present and a greater concentration of flourine fills its place in the anion sublattice to result in a spectral shift toward shorter wavelengths. This shift tends to result in cooler whites or a reduced color temperature. With this adjustment in the formula, it is possible to realize a shift from about λ=560 nm to about λ=510 nm. In this way, these photophosphors may be ‘tuned’ so that they cooperate with a system objective.

To fully appreciate the details of these inventions; one can compare the chemistry of these photophosphors against the chemistry of photophosphors most similar to these. Silicate photophosphors are related to the photophosphors described here throughout. Thus, the following table is presented to yield a clear distinction between silicate photophosphors and halogen silicate photophosphors.

In consideration of the general formula as follows:
M¹ₐM²_{b}M³_{c}SrHal₂O_{d}:(A^{+p})_{q}

Distinction between these two classes of photophosphors is apparent from the presentation of Table 1.

TABLE 1

| Element | Silicate | Halo-Silicate |
|---|---|---|
| M¹ | Mg and/or Ca and/or | Sr and Me = Ba or Yb or |
| (divalent element) | Sr and/or Ba | Sm (Sr:Me = 1 − x:x)* |
| a | 0; 1-q; 2-q; 3-q | 1; 2; 3 |
| M² | Al | — |
| (trivalent element) | | |
| b | 0; 2 | 0 |
| M³ | Si | Si |
| (tetravalent element) | | |
| c | 0; 1; 2; 3 | 1; 2 |
| Sr | — | Sr |
| Hal (halogenids) | — | F and Cl (F:Cl = |
| | | (2 − y):y)** |
| O | O | O |
| d | (2a + 3b + 4c)/2 | 3; 4; 5; 6; 7 |
| A (activator) | Eu and/or Sm | Eu |
| | and/or Yb | |
| +p | +2 | +2 |
| q | 0.001-0.2 | 0.001-0.1 |

*x = 0.001-0.1; **y = 0.01-1.2

It is not that one particular photophosphor composition is presented, but rather an entire family of halo-silicate compostions, or halogen-based silicon compositions. This family includes at least the following particular compositions:
SrO*SiO₂*Sr(F,Cl)₂ or Sr₂SiO₃(F,Cl)₂
2SrO*SiO₂*Sr(F,Cl)₂ or Sr₃SiO₄(F,Cl)₂
3SrO*SiO₂*Sr(F,Cl)₂ or Sr₄SiO₅(F,Cl)₂
SrO*2SiO₂*Sr(F,Cl)₂ or Sr₂Si₂O₅(F,Cl)₂
2SrO*2SiO₂*Sr(F,Cl)₂ or Sr₃Si₂O₆(F,Cl)₂
3SrO*2SiO₂*Sr(F,Cl)₂ or Sr₄Si₂O₇(F,Cl)₂

Other members of this family can also be synthesized if we take for stoichiometric coefficient a=4, 5, or 6, and for stoichiometric coefficient b=3, 4, 5. All the family contains homologous series inside itself such as Sr₂ SiO₃(F,Cl)₂ and Sr₃SiO₄(F,Cl)₂, and Sr₄SiO₅(F,Cl)₂ et cetera, that differ from each other only in additional increasing of combination for a mole SrO.
b=1; a=4; 4SrO*SiO₂*Sr(F,Cl)₂ or Sr₅SiO₆(F,Cl)₂
a=4; b=2; 4SrO*Si₂O₄*Sr(F,Cl)₂ or Sr₅Si₂O₈(F,Cl)₂

There are also binding homologous series in the family, in which gross formula increases for one molecule SiO₂, for example, series Sr₂SiO₃(F,Cl)₂ and Sr₂Si₂O₅(F,Cl)₂. It is necessary to note, that additional replacement of Sr⁺² in a cation sublattice for bivalent metals Ba⁺², Yb⁺², Sm⁺² doesn't change the sequence in homologous series.

In the presented family, a single photoluminescence mechanism is observed, in view of absorption of the primary exciting energy directly by activator ion Eu⁺², surrounded by ions of oxygen, fluorine and chlorine. Such luminescence mechanism is called activator in contrast to the spanning one when the primary excitation energy is absorbed by a crystal frame.

Second, all the stoichiometric compositions of phosphors, forming the offered family, are described and calculated by the same formula by means of indices a, b sequence substitution in it.

Third, the single mechanisms of shift spectrum characteristics of excitation and emission are realized in the offered photophosphor family. So replacing of a part of Sr⁺² ions for large Ba, Yb, Sm ions in a cation sublattice of phosphor matrix is accompanied with a longwave shift of radiation maximum and excitation when increasing concentrations of replacing ions. At the same time in all the offered photophosphors a shortwave shift of excitation and radiation spectrums occurs when adding F⁻¹ ion replacing a large ion Cl⁻¹ into the composition of anion sublattice.

We note here also that additional including of orthosilicate photophosphor into the composition also provides the specific character of its spectrum characteristics. The main spectrum photophosphor radiation band widens and fully shifts for Δ=10-20 nm in comparison with unhalogen orthosilicate. Besides, the duration of afterglow of the main activating ion Eu⁺² increases slightly (for 10%).

Fourth, all photophosphors in this invention are synthesized by a unified method of synthesis. This method includes thermal processing of mixture silicon oxide and strontium hydroxide with the mixture of strontium fluoride and chloride and mixture of barium, ytterbium and samarium nitrides (in case of their including into phosphor composition). During the thermal processing the atmosphere in an oven volume should have reduction potential, i.e. contain in its composition from 1 to 8% H₂ or from 2 up to 20% CO, that is enough for reducing ions of europium, ytterbium, samarium, which initial oxidation level equals +3.

Further important characteristics are associated with these photophosphor groups. These characteristics include: concentration dependence of photophosphor luminescence brightness and the main width of the spectrum maximum. These characteristics are shown in Table 2.

TABLE 2

| | Photophosphor | Concentration | Emission | Luminescence |
|---|---|---|---|---|
| NoNo | Composition | Eu | Peak (nm) | brightness, % |
| 1-1 | Sr₂SiO₃(F,Cl)₂ | 0.005 | 505 | 50 |
| 1-2 | Sr₂SiO₃(F,Cl)₂ | 0.01 | 509 | 60 |
| 1-3 | Sr₂SiO₃(F,Cl)₂ | 0.015 | 515 | 70 |
| 1-4 | Sr₂SiO₃(F,Cl)₂ | 0.02 | 522 | 85 |
| 1-5 | Sr₂SiO₃(F,Cl)₂ | 0.03 | 530 | 105 |
| 1-0 | Sr₂SiO₄:Eu | production piece | 535 | 100 |

Table 3 shows the dependence of the wavelength of the primary emission maximum with respect to replacing strontium ions for Ba⁺², Yb⁺² ions or Sm⁺². The table is presented below:

| | | | | Lumines- |
|---|---|---|---|---|
| | | | Emission | cence |
| | Photophosphor | Concntrn. | Peak | bright- |
| NoNo | Composition | Eu | (nm) | ness, % |
| 2-6 | Sr_{1.8}Ba_{0.2}SiO₃(F,Cl)₂ | 0.02 | 527 | 98 |
| 2-7 | Sr_{1.6}Ba_{0.4}SiO₃(F,Cl)₂ | 0.02 | 540 | 108 |
| 2-8 | Sr_{1.4}Ba_{0.6}SiO₃(F,Cl)₂ | 0.02 | 560 | 114 |
| 2-9 | Sr_{1,2}Ba_{0.8}SiO₃(F,Cl)₂ | 0.02 | 572 | 102 |
| 2-10 | Sr_{1.0}Ba_{1.0}SiO₃(F,Cl)₂ | 0.02 | 582 | 89 |
| 2-11 | Sr_{1.8}Yb_{0.2}SiO₃(F,Cl)₂ | 0.03 | 545 | 94 |
| 2-12 | Sr_{1.6}Yb_{0.4}SiO₃(F,Cl)₂ | 0.03 | 560 | 84 |
| 2-13 | Sr_{1.2}Yb_{0.8}SiO₃(F,Cl)₂ | 0.03 | 585 | 68 |
| 2-14 | Sr_{1.95}Sm_{0.05}SiO₃(F,Cl)₂ | 0.01 | 524 | 86 |
| 2-15 | Sr_{1.93}Sm_{0.07}SiO₃(F,Cl)₂ | 0.01 | 548 | 96 |
| 2-16 | Sr_{1.9}Sm_{0.1}SiO₃(F,Cl)₂ | 0.01 | 555 | 102 |

One will note an increase in the concentration of Ba⁺², Yb⁺², Sm⁺² which replaces the main cation Sr⁺², is accompanied with longwave shift of the main radiation maximum; i.e. a shift to longer wavelengths and warmer ‘whites’. At the same time, a large shift is observed where Sr⁺² is replaced by ions Yb⁺². With regard to Samarium, for a single unit of concentration 0.1 atomic share of replacing ion Sm⁺² the spectrum shifts by an amount of 31 nm. For a shift of 33 nm or more, it is necessary to include [Ba]=0.6 atomic shares, replacing the spanning strontium ion Sr⁺². As such, data presented in Table 2 suggests the possibility of realization in halogen-silicate phosphors one more mechanism of controlling the luminescence spectrum and position of the main spectra emission maxima.

All the experiments described were made using silicate compositions with ratio [SrO*MeO*EuO]:SiO₂=1:1. In compositions of the experimental phosphors, halogenides F⁻¹ and Cl⁻¹ in quantities 1:1 were present. The discovered principles are present for the whole photophosphor family, in which the ratio between bivalent metals oxides and silicon oxides change according to the changes of stoichiometric indices ‘a’ and ‘b’. Testing of a/b ratio influence was made at samples with one activator quantity Eu=0.05 atomic shares and at fixed concentration F:Cl=1:1. Data reflecting this is presented in Table 4.

TABLE 4

| | Photophosphor | Ratio | Emission | Luminescence |
|---|---|---|---|---|
| NoNo | Composition | a/b | Peak (nm) | brightness, % |
| 3-17 | (Sr,Eu)₂SiO₃F,Cl | 1:1 | 550 | 92 |
| 3-18 | (Sr,Eu)₃SiO₄F,Cl | 2:1 | 558 | 100 |
| 3-19 | (Sr,Eu)₄SiO₅F,Cl | 3:1 | 562 | 99 |
| 3-20 | (Sr,Eu)₂Si₂O₅F,Cl | 1:2 | 542 | 89 |
| 3-21 | (Sr,Eu)₃Si₂O₆F,Cl | 2:2 | 544 | 89 |
| 3-22 | (Sr,Eu)₄Si₂O₇F,Cl | 3:2 | 548 | 94 |

Data of Table 4 indicates that increasing the stoichiometric index ‘a’ allows to make a longwave shift of spectra maximum position. However, this shift occurs nonlinearly if organic halogen-silicate Sr₃SiO₄(F₁,Cl₁) at a:b=2:1 is accompanied with maximum shift for Δ=8 nm, than additional including SrO oxide with creating three-strontium-halogen-silicate Sr₄SiO₅(F₁,Cl₁) leads only to a slight shift for Δ=4 nm of spectrum maximum position.

Photophosphor versions having greater concentrations of SiO₂ result in an optical output having a more yellowish-green luminescence. Disilicates produce more shortwave light in comparison with monosilicates which tend to have longer wave outputs. The latter effect of shortwave shift is associated with reconstruction of the crystal lattice of photophosphor matrix. Monosilicate Sr₂SiO₃(F,Cl)₂ rontgenogram this lattice refers to a monoclinic singony, whereas di-strontium halogen silicate has a slightly distorted β—orthorhombic lattice. More complex lattices like three- and four-strontiumdisilicates have a lattice similar to a triclinic one. Density (by weight) of synthesized halo-silicates changes from ρ=3.69 g/cm³ for Sr₂SiO₃(F,Cl)₂ up to ρ=4.45 for Sr₄Si₂O₇(F,Cl)₂.

In this photophosphors family, another wavelength shift mechanism was additionally discovered. A shift mechanism causing the output to move toward shorter wavelengths has not been described heretofore. For clear fluorine silicates radiation with limiting shortwave position of central maximum is observed, for example, for di-strontium, di-fluoride monosilicate where λₘₐₓ=502 nm, then at full replacing of fluoride ions spectrum maximum position shifts almost Δ=52 nm and equals λₘₐₓ=554 nm. Such version may be expresses via the formula: Sr_{1.95}Eu_{0.05}SiO₃Cl₂. It is noted that it is difficult to keep such phosphor in aqueous medium due to high dissolubility of a part of the anion sublattice. The mentioned value Δ=52 nm retains almost for the all examined photophosphor compositions, that's why spectrum maximum position for Sr_{1.8}Ba_{0.2}SiO₃Cl₂:Eu_{0.02} composition is λ=548 nm. For the material in which [Ba] percentage varies from 0.2 up to 1 atomic shares, spectrum maximum position shifts from λ=548 up to λ=602 nm. It was also found that dissolubility of photophosphor base connected with increasing of Cl⁻¹ share in anion sublattice composition depends nonlinearly on the ratio F⁻¹/Cl⁻¹. Maximum high value is achieved for lattices with the ratio F/Cl=0.01/1.99, whereas dissolubility almost decreases for a low value at F⁻¹/C⁻¹=1.05/0.95. It is necessary to consider the influence of photophosphor base dissolubility when synthesizing phosphor matrixes different in concentration. At the same time for phosphor samples with large percent concentration Cl-ion in anion sublattice it is reasonable to use acetone or dehydrated alcohol for washing, whereas compositions with large fluorine concentration resist washing with water, including boiling in water.

The following examples illustrate some techniques used to synthesize the photophosphors described.

### EXAMPLE 1

Mix 0.1M Sr(OH)₂8H₂O; 0.05M SrF₂; 0.05M SrCl₂ with 0.005M europium nitrate (as 1% solution). Add 0.1M silica in the form of its highly dispersated technical trademark “Aerosil 100” into the mixture moistened by water. The mixture is dried at T=120° C. until dusting and is located at an alundum capsule with volume V=250 ml. The capsule is covered with a quartz cover and put to hydrogen conveyor oven in which the atmosphere is maintained with 5% H₂ concentration (95% N₂). The calcination of mixture is realized by means of gradual temperature elevating: T=240° for 1 hour, T=800° for 1 hour, T=1250° for 2 hours. The phosphor sample is cooled with oven cooling, at a rate of about 10°/minute. After cooled to 50° C., the resulting product is washed in a hot water bath with 1% NH₄HF₂ dissolved in it. The washed product Sr₂SiO₃(F,Cl)₂ is dried at T=120° C. for 2 hours, sifted through the sieve with 50.0 micron apertures. Measuring of lighting parameters of the concrete sample 1-1 shows the following results: λₘₐₓ=505 nm at halfwidth of spectrum maximum λ_{0.5}=80 nm. The sample color coordinates at its exciting by electronic beam are x=0.38, y=0.52. Photophosphor median grains dimensions are d₅₀=6 micron, average value is d_{cp}=9.0 micron, grains content with d≧20 micron do not exceed 0.1: mass shares. Photophosphor grains have a volumetric form with clear-cut facets and planes. Mass ratio of photophosphor grains in the organic silicon gel (M=5000 conv. units, polymerization degree is over 250) is 55%. Filling of a light-emitting device chip containing of InGaN—GaN with λₗᵤₘ=405 nm with such suspension allows to receive light-emitting devices with luminous intensity Iᵥ=350 mcd for 20-120° at radiation color coordinates x=0.42, y=0.45.

### EXAMPLE 2

0.08M Sr(OH)₂; 8H₂O 0.02M Ba(OH)₂; 8H₂O; 0.002M Eu(NO₃)₃ (in the form of 0.1% solution) 0.05M SrF₂; 0.05M SrCl₂ are mixed in a parceline bowl V=400 ml. Into a wet mixture 0.1M fine-despersed silica “Aerosil-100” is added and dried until dusting at T=120° C. The mixture is put into alundum capsule V=500 ml, which is located to a hydrogen oven with bulk concentration of hydrogen [H₂]=6%. The sample heating is made gradually, first at T=300° for 1 hour; then at T=900° C. for one additional hour and T=1280° C. for 2 hours. The capsule cooling is made together with the oven cooling with rate of 10°/minute. Thereafter, the sample is washed with a distillated water at T=50° C., dried and sifted through a sieve with 50.0 micron. Photophosphors of Table 2 having number 2-6 has the spectrum maximum position λ=527 with halfwidth λ_{0.5}=85 nm. Photophosphor grains with a median diameter of d₅₀=7.5 micron. Silicon organic phosphor suspension with its mass concentration 45% allows to make light-emitting devices of white-greenish color with color coordinates x=0.38; and y=0.40, the devices luminous intensity was I=320 mcd for 2θ=100°. In comparison with white light-emitting devices based on InGaN and photophosphor made of aluminium yttrium garnet, which chromaticity is characterized by index Rₐ=70 units, the presented photophosphor in combination with a light-emitting device λ=398 nm allows to receive Rₐ=78 units.

### EXAMPLE 3

0.2M Sr(OH)₂; 8H₂O 0.005M Eu(NO₃)₃ (solution 0.1%); 0.05M SrF₂; 0.05M SrCl₂ are mixed in alundum capsule with volume 250 ml. 0.1M SiO₂ is added to a wet mixture, then mixed thoroughly and dried. The capsule is placed in a hydrogen oven of atmosphere: H₂—2%; N₂—98, which is gradually heated up to T=320° C. for 1 hour; T=820° C. for 1 hour; then T=1300° C. for 2 hours. The capsule is taken off at T=50° C., washed by a hot water, sifted through the sieve having 50.0 micron holes. The resulting photophosphor grains have a median diameter d₅₀=4 micron, the average diameter, dₐᵥ is about 6 micron. Phosphor color coordinates are x=0.40, y=0.44. In combination with silicon gel in proportion 30-70 (by mass) the phosphor provides white-rosy luminescence color together with a light-emitting device having a pump wavelength λ=460 nm.

### EXAMPLE 4

For receiving phosphor with composition Sr₄Si₂O₇*F₂:Eu is used 0.3M Sr(OH)₂8H₂O; 0.1M SrF₂; 0.05M Eu(NO₃)₃ (0.1% solution) are mixed together with 0.2M SiO₂. The mixture is dried at T=120° C. for 1 hour, loaded into a hydrogen oven with H₂=10% and N₂=90%. The oven is gradually heated at T=350° C. for 1 hour, and at T=950° C. for 1 hour, finally at T=1350° C. for 2 hours. Thereafter it is cooled at a rate of 10°/minute. The material is washed by the water acidulous with HCl (1:10), dried and sifted through a sieve of 50.0 micron.

The average diameter of photophosphors grains is dₐᵥ=8 micron, the resulting color coordinates are x=0.32; y=0.39. The phosphor suspension made on the base of organic silicon sol 75:25 provides bright white luminescence with green color tint when being put into a light-emitting diode having pump radiation of λ=465 nm. The devices luminous intensity was measured at Iᵥ=380 mcd 2θ_{0.5}=120°.

### EXAMPLE 5

For receiving the composition Sr₃Si₂O₆Cl₂, one may start by mixing 0.2M Sr(OH)₂8H₂O; 0.01M SrCl₂; 0.005M Eu(NO₃)₃ (0.1% solution) with 0.4M SiO₂. The mixture is dried at 120° for 2 hours, put into alundum capsule and placed into a hydrogen oven with H₂=5%, and N₂=95%. The oven is gradually heated at T=400° C. for 1 hour; at T=1000° C. for 1 hour, and finally at T=1280° C. for 3 hours. The cooled product is washed by dehydrated alcohol, then by ethylic ether. The phosphor luminescence color coordinates are x=0.38; and y=0.46 and are retained almost without changes in a UV LED with λ=465 nm. The devices luminous intensity is measured at Iᵥ=400 mcd.

All described photophosphors compositions are made by similar methods. One advantage of presented photophosphor compositions is these materials have a low value for index of refraction. The index of refraction for the whole range of halogen silicate photophosphor compositions varies between about n=1.6 up to about n=1.68. In combination with appropriate light emitting semiconductors, a high luminous intensity and luminescence brightness is possible with halogen-silicate photophosphors partly due to such low index of refraction value.

The examples above are directed to specific embodiments which illustrate preferred versions of devices and methods of these inventions. In the interests of completeness, a more general description of devices and the elements of which they are comprised as well as methods and the steps of which they are comprised is presented herefollowing.

We claim:

1) Compositions of matter in accordance with:
((SrO)₁₋ₓ[Me]Oₓ)ₐ*(SiO₂)_{b}*Sr(F_{2-y}Cl_{y}):(EuO)_{z}
where ‘a’ is an integer between 1 and 6; ‘b’ is an integer between 1 and 5; x=0.1-0.001; y=0.01-1.2; z=0.001-0.1; and [Me] is a metal from the group: Ba⁺², Yb⁺², and Sm⁺².

2) Compositions of matter of claim 1, further defined as:
SrO*SiO₂*Sr(F,Cl)₂ or Sr₂SiO₃(F,Cl)₂

3) Compositions of matter of claim 1, further defined as:
2SrO*SiO₂*Sr(F,Cl)₂ or Sr₃SiO₄(F,Cl)₂

4) Compositions of matter of claim 1, further defined as:
3SrO*SiO₂*Sr(F,Cl)₂ or Sr₄SiO₅(F,Cl)₂

5) Compositions of matter of claim 1, further defined as:
SrO*2SiO₂*Sr(F,Cl)₂ or Sr₂Si₂O₅(F,Cl)₂

6) Compositions of matter of claim 1, further defined as:
2SrO*2SiO₂*Sr(F,Cl)₂ or Sr₃Si₂O₆(F,Cl)₂

7) Compositions of matter of claim 1, further defined as:
3SrO*2SiO₂*Sr(F,Cl)₂ or Sr₄Si₂O₇(F,Cl)₂

8) In combination, a light emitting semiconductor and halogen-silicate photophosphors, said light emitting semiconductor proximately positioned with respect to said halogen-silicate photophosphor whereby some of light emitted by the semiconductor interacts with the photophosphor and is shifted in wavelength via phosphor re-emission.

9) The combination of claim 8, said light emitting semiconductor is an InGaN diode structure.

10) The combination of claim 8, said photophosphor is prepared with an halogen activator in accordance with: Sr(F_{2-y}Cl_{y}).

11) Compositions of claim 8, said material is formed as crystals having a crystalline structure characterized triagonal.

12) Compositions of claim 8, said matter is formed as crystals having a mean crystal size between 8 and 40 times its peak emission wavelength.

13) The combination of claim 8, where ‘proximately positioned’ is further defined as a colloid formed as a phosphor-polymer suspension being coated over said semiconductor light emitter.

14) The combination of claim 12, said polymer is further defined as a polyethylsiloxane or polyepoxide having mass about between 2000 to 20000 carbon units.

15) The combination of claim 12, phosphor-polymer by mass is between 0.1 and 0.75.

16) The combination of claim 14, said polymer is formed as a layer having a thickness between about 20-100 microns.
